(19) United States
(12) Patent Application Publication
(10) Pub. No.: US 2013/0259354 A1
(43) Pub. Date: Oct. 3, 2013

(54) IRRADIATION FIELD RECOGNITION APPARATUS, IRRADIATION FIELD RECOGNITION METHOD, AND COMPUTER-READABLE STORAGE MEDIUM

(71) Applicant: CANON KABUSHIKI KAISHA, Tokyo (JP)

(72) Inventor: Naoto Takahashi, Sagamihara-shi (JP)

(73) Assignee: CANON KABUSHIKI KAISHA, Tokyo (JP)

(21) Appl. No.: 13/801,382

(22) Filed: Mar. 13, 2013

(30) Foreign Application Priority Data
Mar. 29, 2012 (JP) 2012-076770

(51) Int. Cl. G06T 7/00

(52) U.S. Cl. CPC G06T 7/0012
USPC 382/132

(57) ABSTRACT

An irradiation field recognition apparatus that acquires information on a profile line of an irradiation field, onto which radiation is irradiated, from an image obtained by a radiation sensor includes an acquisition unit configured to acquire coordinates on the image input by an operator, and an irradiation field recognition unit configured to acquire information on the profile line from a range on the image which is limited based on the coordinates.

### BACKGROUND OF THE INVENTION

1. Field of the Invention

The present invention relates to a technology that recognizes an irradiation field, onto which radiation is irradiated, from image data.

2. Description of the Related Art

Recently, with the advance of the development of a digital technology in a medical radiation imaging apparatus, digital radiation imaging apparatuses which use various methods are widely spread. For example, a method, which uses a radiation detector which is a radiation sensor in which a fluorescent material is closely adhered with a large area amorphous silicon sensor and directly digitalizes a radiation image without using an optical system, is put to practical use. Further, a method, which uses amorphous selenium to directly photoelectrically convert a radiation to be converted into an electron and detects the electron using the large area amorphous silicon sensor, is also put to practical use.

However, in the radiation imaging, in order to suppress other areas than a necessary area from being exposed to the radiation and prevent the contrast from being lowered due to the scattering of radiation from the area other than the necessary area, the radiation is generally irradiated only on the necessary area, which is referred to as irradiation field reduction. In this case, on the image data acquired by the radiation imaging apparatus, a region where the radiation is directly received and a region where radiation other than secondary light such as a scattering radiation is not received are formed. The region where the radiation is directly received on the image data is referred to as an irradiation field, and the region where the radiation other than the secondary light such as the scattering radiation is hardly received is referred to as a non-irradiation field.

Further, when image processing is performed on the image data, the processing is generally performed based on the irradiation field. Therefore, a method that automatically recognizes the irradiation field from the image data in advance is suggested.

According to a method discussed in Japanese Patent Application Laid-Open No. 2006-333922, a plurality of candidate lines, which is presumed to represent a boundary of the irradiation field, is extracted, a profile line obtained by the combination of the candidate lines is evaluated, and a profile line having the highest evaluation value is automatically recognized as the boundary of the irradiation field.

However, in the method that automatically recognizes the irradiation field as described above, it is difficult to precisely recognize the irradiation field at all times, and in some cases, the irradiation field is erroneously recognized. Therefore, a correction method used when the irradiation field is erroneously recognized is discussed in Japanese Patent Application Laid-Open No. 10-154226. According to the method, when the irradiation field which is automatically recognized is incorrect, coordinate data for the boundary of the irradiation field is sequentially input using a mouse and a region within a boundary obtained by connecting the coordinate data is set as a correct irradiation field.

Further, in Japanese Patent Application Laid-Open No. 10-286249, when the irradiation field which is automatically recognized is incorrect, auxiliary information for the irradiation field is selectively input and the irradiation field is automatically recognized again based on the auxiliary information.

However, among the correction methods of the irradiation field as described above, in the method discussed in Japanese Patent Application Laid-Open No. 10-154226, it is required to necessarily input a plurality of pieces of coordinate data for the boundary of the irradiation field when the irradiation field is erroneously recognized. Specifically, if the irradiation field is a rectangular shape, coordinate data of at least four apexes need to be necessarily input but the manipulation is complex so that it takes time to perform any correction job.

Further, in the method discussed in Japanese Patent Application Laid-Open No. 10-286249, the auxiliary information is selectively input instead of directly inputting the coordinate data for the boundary of the irradiation field so that the irradiation field is simply corrected. However, if the irradiation field is incorrect, an operator does not intuitively know which information needs to be input as appropriate auxiliary information, so that inappropriate auxiliary information may be input. In this case, since the irradiation field is not correctly corrected, another auxiliary information may be input again, so that it takes time to perform any correction job.

### SUMMARY OF THE INVENTION

The present invention is directed to a method that allows an operator to intuitively know that the irradiation field is erroneously recognized and to simply correct the irradiation field.

According to an aspect of the present invention, an irradiation field recognition apparatus that acquires information on a profile line of an irradiation field, onto which radiation is irradiated, from an image obtained by a radiation sensor, includes an acquisition unit configured to acquire coordinates on the image input by an operator, and an irradiation field recognition unit configured to acquire information on the profile line from a range on the image which is limited based on the coordinates.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a diagram illustrating an entire configuration of a radiation imaging apparatus according to first and second exemplary embodiments.

FIG. 2 is a flow chart illustrating a processing procedure of an irradiation field recognition unit according to the first exemplary embodiment.

FIG. 3 is a flow chart illustrating a processing procedure of an irradiation field recognition unit according to the second exemplary embodiment.

FIGS. 4A and 4B are views illustrating a method of extracting a plurality of profile lines using a first irradiation field recognition unit.

FIGS. 5A and 5B are views illustrating an overlay display method.

FIGS. 6A and 6B are views illustrating a coordinate specifying method.

FIG. 7 is a view illustrating a method of extracting a plurality of profile lines using a second irradiation field recognition unit.

### DESCRIPTION OF THE EMBODIMENTS

Various exemplary embodiments, features, and aspects of the invention will be described in detail below with reference to the drawings.

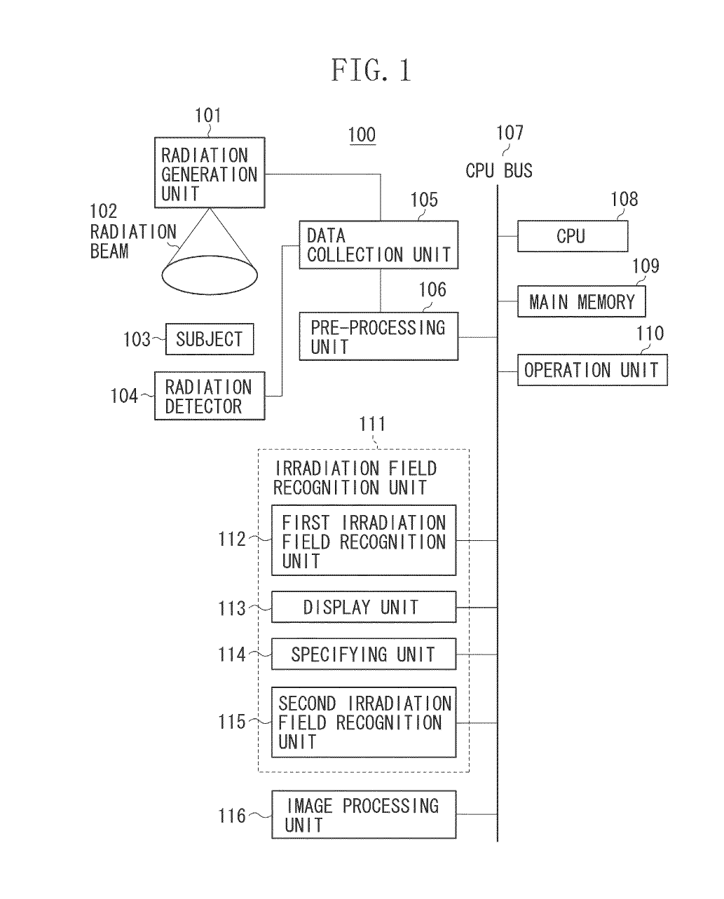

A first exemplary embodiment of the present invention is applied to, for example, a radiation imaging apparatus 100 as illustrated in FIG. 1. In other words, the radiation imaging apparatus 100 is a radiation imaging apparatus having an irradiation field recognizing function. The radiation imaging apparatus 100 includes a radiation generation unit 101, a radiation detector 104, which is a radiation sensor, a data collection unit 105, a pre-processing unit 106, a central processing unit (CPU) 108, a main memory 109, an operation unit 110, an irradiation field recognition unit 111, and an image processing unit 116, which are connected via a CPU bus 107 so as to transmit data to each other.

The irradiation field recognition unit 111 recognizes an irradiation field, onto which radiation is irradiated, from image data and includes a first irradiation field recognition unit 112, a display unit 113, a specifying unit 114, and a second irradiation field recognition unit 115. In addition, these component units are connected to the CPU bus 107.

In the radiation imaging apparatus 100 as described above, first, the main memory 109 stores various data which is required for processing in the CPU 108 and also functions as a working memory for the CPU 108. The CPU 108 uses the main memory 109 to control the operation of the entire apparatus according to the operation on the operation unit 110. By doing this, the radiation imaging apparatus 100 operates as described below.

First, if an imaging instruction is input from a user via the operation unit 110, the imaging instruction is transmitted to the data collection unit 105 by the CPU 108. When the CPU 108 receives the imaging instruction, the CPU 108 controls the radiation generation unit 101 and the radiation detector 104 to perform radiation imaging.

In the radiation imaging, first, the radiation generation unit 101 irradiates a radiation beam 102 onto a subject 103. The radiation beam 102, which is irradiated from the radiation generation unit 101, is transmitted through the subject 103 while being attenuated and then reaches the radiation detector 104. Then, the radiation detector 104 outputs a signal corresponding to the intensity of the reached radiation. In addition, in the present exemplary embodiment, the subject 103 is a human body. Thus, the signal output from the radiation detector 104 is data obtained by imaging the human body.

The data collection unit 105 converts the signal output from the radiation detector 104 into a predetermined digital signal and supplies the converted signal to the pre-processing unit 106 as image data. The pre-processing unit 106 performs pre-processing such as offset correction or gain correction on the image data supplied from the data collection unit 105. The image data on which the pre-processing is performed by the pre-processing unit 106 is sequentially transmitted to the main memory 109 and the irradiation field recognition unit 111 via the CPU bus 107. Further, in the present exemplary embodiment, even though the irradiation field recognition unit 111 uses the image data which is processed by the pre-processing unit 106, the irradiation field recognition unit 111 has the same function even for image data on which the pre-processing is not performed.

The irradiation field recognition unit 111 recognizes the irradiation field, on which radiation is irradiated, from the image data and generates information about the irradiation field. The image processing unit 116 performs various image processing operations on the image data based on the information about the irradiation field. An example of the image processing includes gradation processing that obtains a histogram of pixel values of the irradiation field and optimizes the density and contrast of a region of interest. Further, mask processing that marks out the density of a non-irradiation field with black or processing that cuts out only the irradiation field to output the cut irradiation field to a printer, which is not illustrated, is performed.

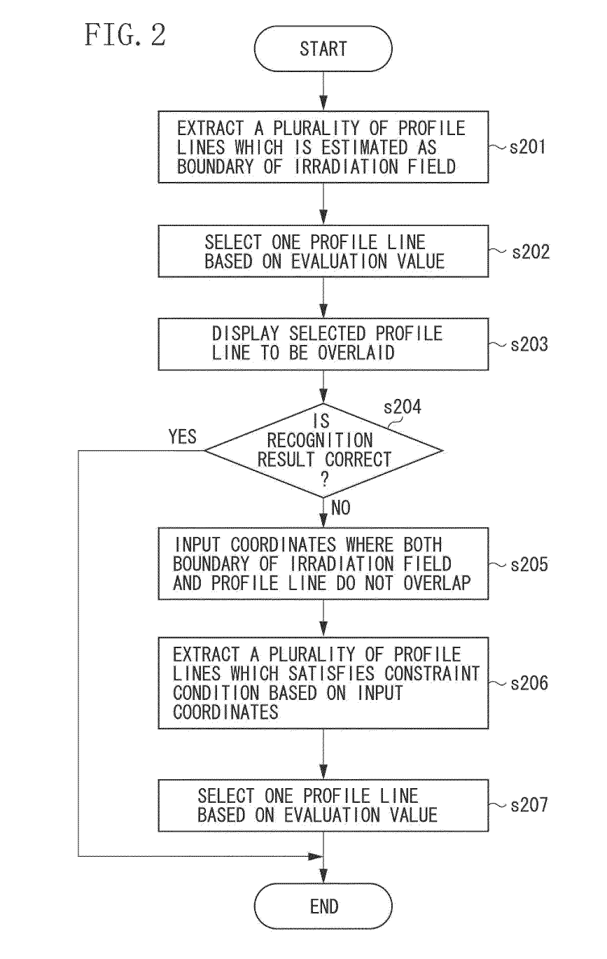

In the radiation imaging apparatus 100 with the above configuration, an operation of the irradiation field recognition unit 111, which is a feature of the present exemplary embodiment, will be specifically described with reference to a flowchart illustrated in FIG. 2.

As described above, the image data which is obtained by the pre-processing unit 106 is transmitted to the irradiation field recognition unit 111 via the CPU bus 107, and the first irradiation field recognition unit 112 recognizes a profile line which is presumed to represent a boundary of the irradiation field. Here, even though a specific method that recognizes the irradiation field is not specifically limited, but in the present exemplary embodiment, a method discussed in, for example, Japanese Patent Application Laid-Open No. 2006-333922 is used.

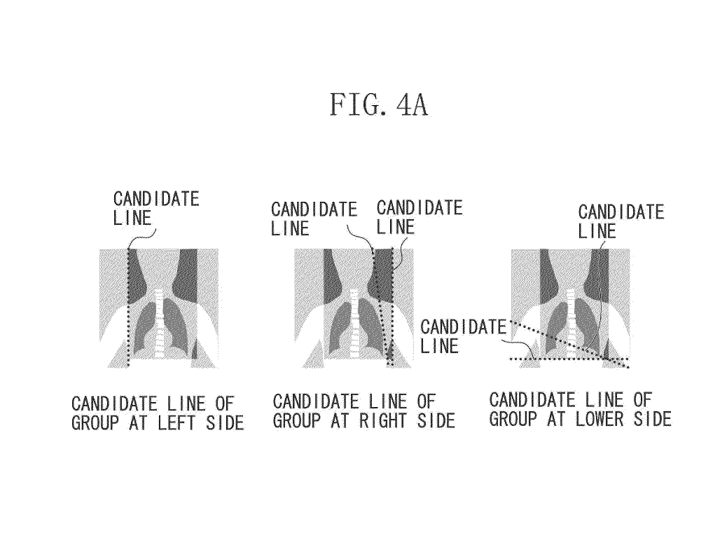

In this method, first, a candidate line, which is presumed to be a boundary of the irradiation field, is grouped at every side, and a plurality of profile lines, which is configured by a combination of the candidate lines belonging to each of the group, is extracted (step s201). For example, as illustrated in FIG. 4A, if, in image data obtained by capturing an image of the front of a thoracic vertebra where irradiation field reduction at left, right, and lower sides is performed, one candidate line as a group at the left side, two candidate lines as a group at the right side, and two candidate lines as a group at the lower side are extracted, all profile lines, which are configured by the combination when one or less candidate line is selected from each group (excluding a case when no candidate line is selected from all groups), are extracted (in this case, 17 candidate lines illustrated in FIG. 4B are extracted).

Next, evaluation values for a plurality of extracted candidate lines are calculated and one candidate line having the highest evaluation value, that is, the highest possibility of having a boundary of the irradiation field is selected as a profile line (step s202). Specifically, for example, the boundary of the irradiation field is more likely to be a comparatively steep edge. Therefore, a summation of gradient values of edges on each candidate line is calculated as a first evaluation value, and a candidate line having the highest first evaluation value is selected as a profile line.

Further, the evaluation value calculating method is not limited thereto. For example, in addition to the summation of gradient values of edges, a feature vector, which has a plurality of values regarding a feature, such as an average of gradient values of edges, and an average or an area of a region surrounded by the profile lines as an element, is obtained and the first evaluation value may be calculated by an evaluation function which has the feature vector as an input.

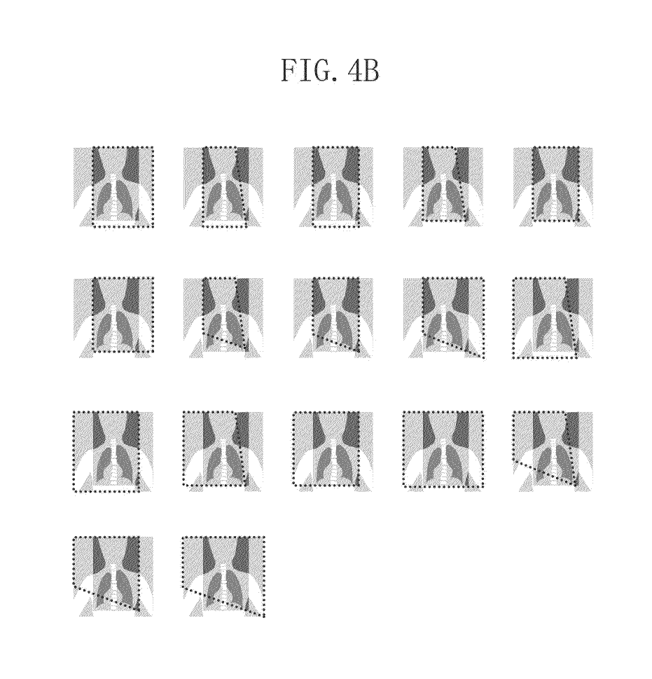

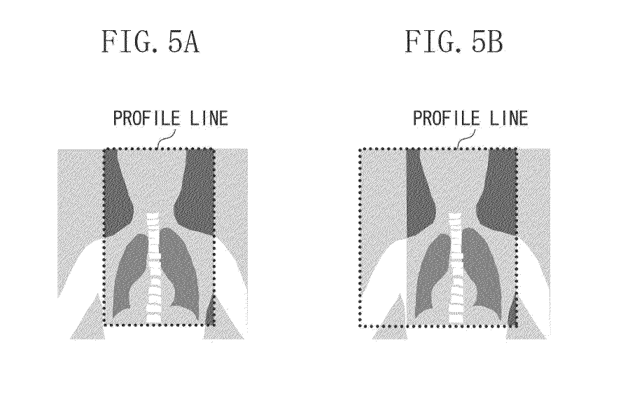

Next, a display controller, which functions as a display control unit which is not illustrated, displays the selected profile line on the display unit 113 such as a television monitor, a liquid crystal screen, or a touch panel so as to be overlaid on the image as illustrated in FIG. 5A or 5B (step s203).

Here, if the selected profile line matches the boundary of the irradiation field as illustrated in FIG. 5A (the recognition result is correct), the processing ends. In contrast, if the selected profile line does not match boundary of the irradiation field as illustrated in FIG. 5B (the recognition result is not correct), the next step is performed (step s204).

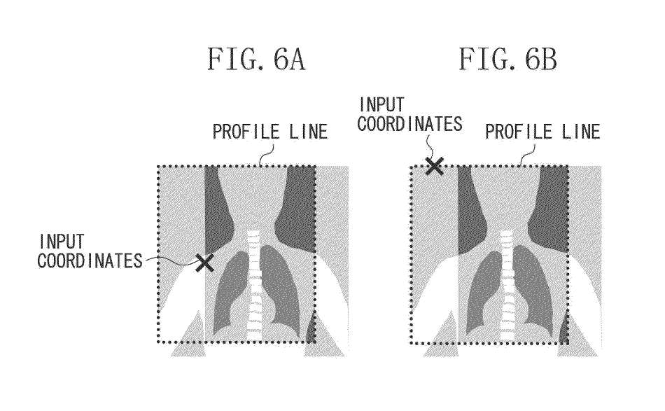

Next, if the selected profile line does not match the boundary of the irradiation field, coordinates where both the boundary of the irradiation field and the profile line do not overlap are input in the specifying unit 114. In the present exemplary embodiment, for example, as illustrated in FIG. 6A, coordinates, which are not on the profile line displayed to be overlaid on the boundary of the correct irradiation field, are input by the operator via a mouse or a touch panel, which serves as the specifying unit 114. An acquisition portion (not illustrated), which serves as an acquisition unit, acquires the coordinates on the image input by the operator. Here, a profile line is re-selected from the candidate line using a distance from the coordinates on the image as a second evaluation value.

Further, by doing this, the candidate line may be preferentially selected from a range which is limited based on the coordinates indicated by the operator.

In this case, as the distance from the coordinates is increased, the second evaluation value is lowered. Further, an additional value to which weighted values of the first evaluation value and the second evaluation value are applied is used as an evaluation value in general case.

However, in some cases, as the operator more frequently inputs the coordinates using a mouse or a touch panel, which serves as the specifying unit 114, the weighted value of the second evaluation value may be more frequently applied. As the indication number of coordinates from the operator is increased, the weighted value of the second evaluation value is increased so that it is easy to reflect the intention of the user.

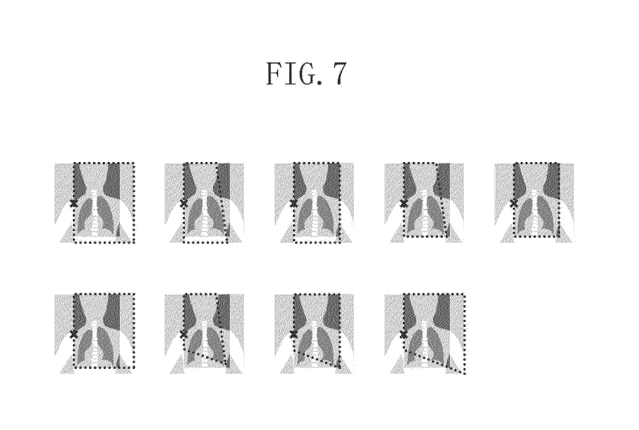

Next, the second irradiation field recognition unit 115 recognizes the irradiation field based on the input coordinates. Here, a plurality of profile lines, which satisfies a constraint condition based on the input coordinates, is extracted (step s206). Specifically, a plurality of profile lines is extracted similarly to step s201 and then only a profile line, which satisfies the constraint condition, is selected from the plurality of extracted profile lines. Here, in the present exemplary embodiment, in order to input correct coordinates on a boundary of an irradiation field in step s205, as illustrated in FIG. 7, only profile lines, which pass around the input coordinates, are selected from the plurality of profile lines illustrated in FIG. 4B as a candidate.

Next, one of the plurality of selected profile lines having the highest evaluation value, that is, a candidate which is most likely to be a boundary of the irradiation field is selected (step s207). Here, the evaluation value is calculated similarly to step s202. However, a plurality of candidates, which includes incorrectly selected profile lines in step s202, is dismissed in advance, so that a candidate may be selected more precisely than in step s202.

Further, in the present exemplary embodiment, an example in which the operator inputs one set of coordinates in step s205 has been described. However, even when two or more sets of coordinates are input, the present exemplary embodiment may be similarly performed. In this case, only a profile line which passes around all input coordinates may be selected as a candidate in step s206. In addition, if there is no profile line which passes around the input coordinates, a new candidate line is obtained using a known technology, such as a Hough transformation, and a plurality of profile lines, which is configured by a combination including the obtained candidate line, may be extracted again.

Further, in the present exemplary embodiment, even though coordinates, which are not on the profile line displayed to be overlaid on the boundary of the correct irradiation field as illustrated in FIG. 6A, are input, coordinates, which are on the profile line displayed to be overlaid but not on the boundary of the correct irradiation field, may be input as illustrated in FIG. 6B. In this case, if only a profile line, which does not pass around the input coordinates, is selected as a candidate in step s206, the same effect may be achieved. In addition, a method that inputs coordinates is set on each of buttons in advance, so that a configuration that may simultaneously input both methods may also be achieved.

As described, in the first exemplary embodiment, if the irradiation field is incorrectly recognized, coordinates in which both the boundary of the irradiation field and the profile line displayed to be overlaid do not overlap are input. Therefore, the input coordinates are apparent on the image, so that the operator may intuitively know the input coordinates. Further, the irradiation field is recognized again so as to satisfy the constraint condition based on the input coordinates, so that the recognition of the irradiation field may be appropriately corrected.

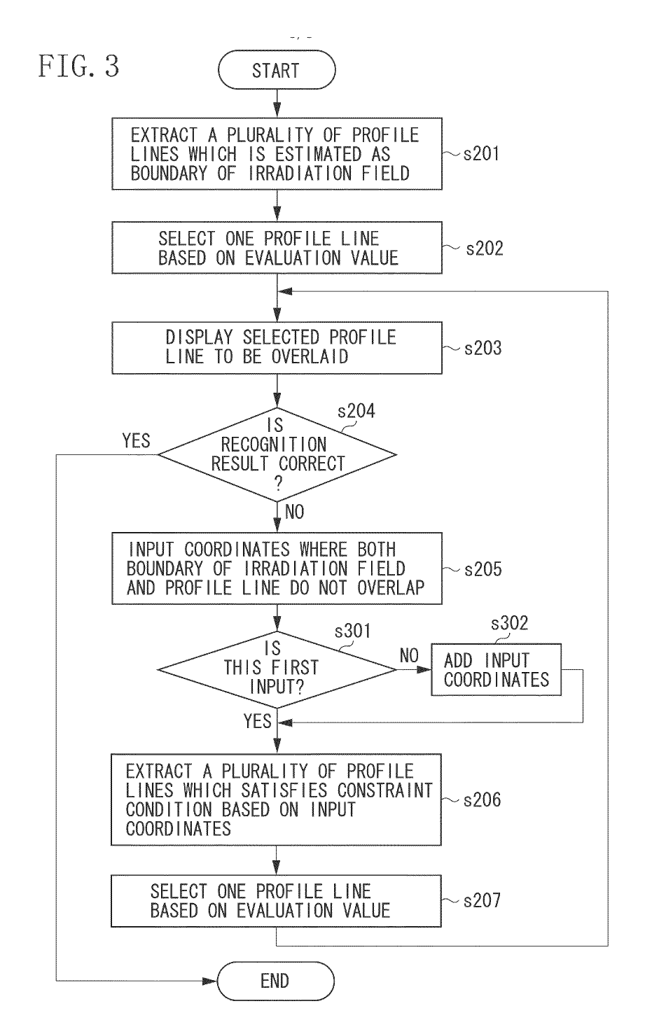

In a second exemplary embodiment of the present invention, in the radiation imaging apparatus 100, the operation of the irradiation field recognition unit 111 is performed according to the flowchart of FIG. 3, which is different from the first exemplary embodiment. Further, in the flowchart illustrated in FIG. 3, steps that perform the same processing as in the flowchart illustrated in FIG. 2 are denoted by the same reference numerals and only a different configuration from the first exemplary embodiment will be described in detail. In addition, in the second exemplary embodiment, operations in steps s203 to s207 in the first exemplary embodiment are repeatedly performed.

First, steps s201 to s203 are performed similarly to the first exemplary embodiment and a selected profile line is displayed to be overlaid on the image. Next, if the recognition result is correct (YES in step s204), the processing ends. In contrast, if the recognition result is incorrect (NO in step s204), one set of coordinates where both a boundary of an irradiation field and a profile line do not overlap is input (step s205).

Next, if the input is the first input (YES in step s301), steps s206 and s207 are performed to recognize the irradiation field based on the input coordinates. Here, the profile line selected in step s207 is displayed again to be overlaid on the image (step s203).

Next, if the re-overlay-displayed recognition result is correct, the processing ends. In contrast, if the recognition result is incorrect, one set of coordinates where both a boundary of an irradiation field and a profile line do not overlap is additionally input (step s205).

Here, in the case of second or later input, in addition to the coordinate which is already input, a new set of coordinates is added (step s302) and steps s206 and s207 are performed to recognize the irradiation field based on all input coordinates.

Next, the operations of steps s203 to s207 are repeatedly performed on the profile line selected in step s207 until the recognition result becomes correct.

As described above, in the second exemplary embodiment, if the irradiation field is incorrectly recognized, whenever one set of coordinates is input, the correction result of the recognition of the irradiation field is repeatedly displayed to be overlaid. Therefore, the operator may input coordinates while checking the profile line displayed to be overlaid at every time and thus unnecessary input may be reduced as compared with the first exemplary embodiment and the recognition of the irradiation field may be appropriately corrected.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2012-076770 filed Mar. 29, 2012, which is hereby incorporated by reference herein in its entirety.

What is claimed is:

1. An irradiation field recognition apparatus that acquires information on a profile line of an irradiation field, onto which radiation is irradiated, from an image obtained by a radiation sensor, the irradiation field recognition apparatus comprising:
an acquisition unit configured to acquire coordinates on the image input by an operator; and
an irradiation field recognition unit configured to acquire information on the profile line from a range on the image which is limited based on the coordinates.

2. The irradiation field recognition apparatus according to claim 1, wherein the irradiation field recognition unit selects the profile line from a candidate line using a summation of values representing a distance from the coordinates and a gradient of the image on the candidate line as a first evaluation value.

3. The irradiation field recognition apparatus according to claim 2, wherein the irradiation field recognition unit selects the profile line from a plurality of candidate lines, which is a candidate of the profile line, using a distance from the coordinates as a second evaluation value.

4. The irradiation field recognition apparatus according to claim 3, wherein the irradiation field recognition unit selects the profile line from a plurality of candidate lines, which is a candidate of the profile line, as a new evaluation value by weighting the first evaluation value and the second evaluation value.

5. The irradiation field recognition apparatus according to claim 4, wherein as an indication number of coordinates by the operator is increased, a weight of the second evaluation value is increased.

6. The irradiation field recognition apparatus according to claim 1, wherein the irradiation field recognition unit selects the profile line from a plurality of candidate lines, which is a candidate of the profile line, based on information indicating a gradient of the image.

7. The irradiation field recognition apparatus according to claim 6, wherein the irradiation field recognition unit selects the profile line using a summation of values indicating a gradient of the image on the candidate line as an evaluation value.

8. The irradiation field recognition apparatus according to claim 1, further comprising:
a display control unit configured to display the profile line recognized by the irradiation field recognition unit to be overlaid on the image.

9. The irradiation field recognition apparatus according to claim 1, further comprising:
a specifying unit configured to allow the operator to specify the coordinates.

10. The irradiation field recognition apparatus according to claim 9, wherein whenever a new set of coordinates is additionally specified by the specifying unit, the irradiation field recognition unit acquires information on a new profile line.

11. The irradiation field recognition apparatus according to claim 9, wherein the specifying unit specifies coordinates which are not on the recognized profile line, on a boundary of the irradiation field.

12. The irradiation field recognition apparatus according to claim 9, wherein the specifying unit specifies coordinates which are not on a boundary of the irradiation field, on the recognized profile line.

13. The irradiation field recognition apparatus according to claim 12, further comprising:
a second irradiation field recognition unit configured to acquire information on a profile line indicating the boundary of the irradiation field under a constraint that the profile line does not pass through the coordinates specified by the specifying unit.

14. An irradiation field recognizing method for acquiring information on a profile line of an irradiation field, onto which radiation is irradiated, from an image obtained by a radiation sensor, the irradiation field recognizing method comprising:
acquiring coordinates on the image input by an operator; and
acquiring information on the profile line from a range on the image which is limited based on the coordinates.

15. A computer-readable storage medium storing a program that causes a computer to execute the irradiation field recognizing method according to claim 14.
